(19) United States
(12) Patent Application Publication
(10) Pub. No.: US 2017/0077771 A1
(43) Pub. Date: Mar. 16, 2017

(54) STEEL-MAGNET EMBEDDED MIXED EXCITATION MOTOR

(71) Applicant: Changzhou Pushi Automotive Power Systems Co., Ltd., Changzhou (CN)

(72) Inventor: Yang Shen, Changzhou (CN)

(21) Appl. No.: 15/093,407

(22) Filed: Apr. 7, 2016

(30) Foreign Application Priority Data
Sep. 14, 2015 (CN) 201510607042.6

(51) Int. Cl. H02K 1/22; H02K 3/487; H02K 1/32; H02K 1/02

(52) U.S. Cl. CPC H02K 1/223; H02K 1/02; H02K 3/487; H02K 1/32

(57) ABSTRACT

The present invention relates a steel-magnet embedded mixed excitation motor, comprising a stator and a rotor disposed in said stator; wherein said stator contains a stator core with armature windings embedded therein; wherein said rotor further comprising a rotor sheet, steel magnets and an excitation winding; wherein said steel-magnet embedded mixed excitation motor further comprising a stator and rotor that are made from stalloy; wherein said rotor sheet further comprising a plurality of evenly dispersed punching slots, wherein said rotor further comprising several poles; wherein said steel magnets are embedded in said poles at the side near the excircle, wherein said steel magnets are distributed alternately following the pole N and the pole S of said rotor; and wherein said excitation windings are directly spooled on the poles of said rotor and distributed alternately counterclockwise and clockwise following said pole N and said pole S of said rotor.

### BACKGROUND

Technical Field

The present disclosure relates to the field of excitation motors and more particularly, to a steel-magnet embedded mixed excitation motor.

Description of Related Art

In recent years, motor drives have placed significantly greater requirements on the peak torque of the motor and rotation speed due to the rise of alternative energy sources in the automobile industry. To meet these requirements and lower production costs, the motor system is required to have a larger reluctance torque share. Regarding foreign and domestic motor companies, the shared proportion of salient pole reluctance torque of the motor to the torque produced by PM (permanent magnetism) steel magnet is lower than 45%. However, increasing this proportion can effectively reduce the motor system cost and improve power performance. In a hybrid power vehicle system, the available space is reduced, posing greater limitations on the power density of motor, Therefore, further improvement in the motor's power torque density is required. Additionally, the popularization of industrial servo motors and the electric drive rate of vehicles requires a reduced cost in motor production. Further, the rare earth steel magnet, which is the critical material influencing the cost of producing the motor, is a limited resource. Using ferrite as a substitute for rare earth would significantly reduce production costs.

Although the motor system of the hybrid power vehicle requires the motor to be able to provide larger output torque and operate at higher rotation speed (constant power speed adjustment scope exceeds 6 times), the constant power speed control scope of the PM synchronous motor currently used in a conventional motor is often less than 3 times. Other available motor systems perform even more poorly than conventional motors. The mixed excitation synchronous motors in the existing market are mostly of axial magnetic structure, which basically realize output power and speed adjustment scope of the motor. However, as low-emission and lightweight technology in vehicles are improved, the mixed excitation motor with axial magnetic circuitry fails to meet the stricter work efficiency and power density requirements of automobiles that increasingly utilize alternative sources of energy, e.g., hybrid vehicles. Therefore, a solution taking into account both high torque and wide rotation speed is urgently needed in the current automobile environment.

Publication No. CN101621235 discloses a motor that can which resolve the existing issues of copper degradation in a permanent magnet, as well as partly reducing the motor system costs. However, the referenced patent fails to achieve a larger speed adjustment scope.

Application No. 201510095867.4 discloses a mixed excitation motor, including a stator and a rotor disposed in the stator. The rotor includes a rotor rack constituting the main support part of the rotor, as well as the steel magnets and the excitation windings, which are disposed on the rotor rack. Several motor poles are evenly disposed along a circle of cross section of the rotor rack. In addition, the first steel magnets composed of permanent magnets are arranged between the adjacent motor poles. The second steel magnets composed of permanent magnets and the excitation windings are arranged in the motor poles. The first steel magnets and the second steel magnets have the same pole on the ends near the circle of the rotor. The volume of the first steel magnets is greater than the volume of the second steel magnets. Although the mixed excitation motor made by this technology has a larger speed adjustment scope and less consumption of rare earth, production and marketing of this motor are difficult due to its complex structure and high cost.

### BRIEF SUMMARY OF THE INVENTION

It is the object of the present disclosure to provide a steel-magnet embedded mixed excitation motor which has a larger speed adjustment speed and less consumption of rare earth, and is simple in structure, and easy for production and popularization and low cost, to solve above technical problems in prior art.

The present disclosure is realized by following technical solution that:

A steel-magnet embedded mixed excitation motor, including a stator 9 and a rotor 10 disposed in the stator 9. The stator 9 is made of a stator core 2 with armature windings 1 embedded therein; and the rotor 10 includes a rotor sheet 5, the steel magnets 6 and an excitation winding 3, wherein the stator 9 and the rotor 10 are made of stalloy. The rotor sheet 5 has several evenly dispersed punching slots, which makes the rotor 10 form several poles. The steel magnets 6 are embedded in the poles at the side near excircle and are distributed alternately following the pole N and the pole S of the rotor 10. Excitation windings 3 are directly spooled on the poles of rotor 10. The excitation windings 3 are alternately distributed counterclockwise and clockwise following the pole N and the pole S of the rotor 10.

Further, the steel magnets 6 are of radial magnetizing type.

Further, the quantity of the poles is equal to the number of the poles of the motor.

Further, the steel magnets 6 are arranged under the pole N of the rotor 10 and the excitation windings 3 under the pole S of the rotor 10.

Further, the steel magnets 6 are arranged under the pole S of rotor 10 and the excitation windings 3 are arranged under the pole N of the rotor 10.

Further, the stator 9 is composed of a concentrated winding structure or distributed winding structure.

Further, the symmetrical flutes 7 are arranged on the punching slots at the side near excircle, and the flute wedges 8 are arranged in the symmetrical flutes 7.

Further, several accessory holes 4 are formed in the inner side of the rotor sheet 5.

Further, heat-emission holes 11 are formed in the middle, near the steel magnets 6, of the rotor sheet 5.

Further, the steel magnets 6 are at the middle position of the poles, and the dimension of the distance between the two sides of the steel magnets 6 and the punching slots is less than or equal to the dimension of the distance between the two sides of the steel magnet 6 and the excircle edge of the rotor 10.

The present invention provides the following advantages:

The structure of the present invention is relatively simple, thereby reducing the production and marketing process associated with the present invention.

The motor in the present invention offers the advantages of a wide scope of work rotation, high power density, simple manufacturing process and reducing the costs associated with using rare earth steel magnets.

The motor of the present invention is particularly applicable to the generators of automobiles with larger power, which can effectively improve the magnetic moment density and rotational work of the motor system. It can also be used as a motor drive, which effectively improve the power density of the motor.

Software simulations related to motor performance indicate that given equal excitation load currents, the peak torque of the motor in the present invention is greater than 5 times that of the conventional excitation device;

The stator and rotor of the present device are made from stalloy. No lines of magnetic force need to pass axial direction, which will significantly improve the power density and efficiency of the motor relative to the motor with an axial (lundell) magnetic circuit structure.

### BRIEF DESCRIPTION OF THE DRAWINGS

FIG. 1 is a structural diagram of the present disclosure;

FIG. 2 is a schematic diagram of the pattern of the motor magnetic field lines in the absence of an exciting current;

FIG. 3 is a schematic drawing of the motor magnetic field lines in the case of positive excitation (smaller current value) in the positive direction of the present disclosure;

FIG. 4 is a schematic drawing of the motor magnetic field lines in the case of excitation (bigger current value) in the positive direction of the present disclosure;

FIG. 5 is a schematic diagram of the load magnetic field distribution in a conventional excitation motor;

FIG. 6 is a schematic drawing of the load magnetic field distribution in the case of the present invention's embedded steel magnet mixed excitation motor.

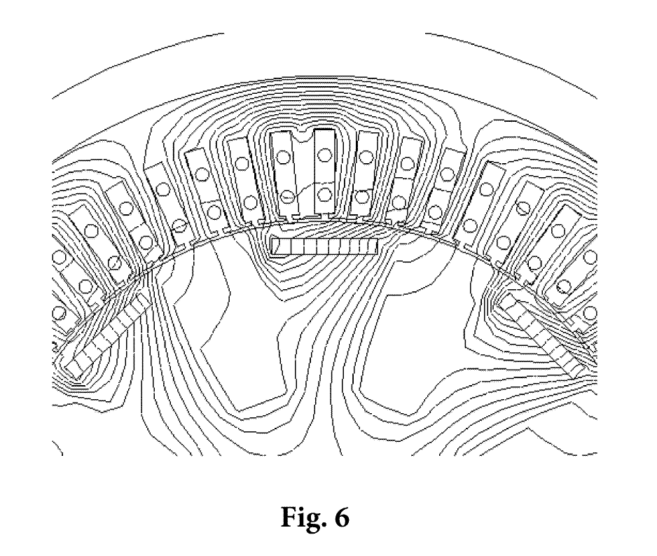

### DETAILED DESCRIPTION OF THE INVENTION

All features disclosed or the steps of all methods or process disclosed in this specification may be combined in any way except features and/or steps, which are mutually inconsistent.

Unless particularly stated, any features disclosed in this specification (including any accessory claims, abstract and accompanying drawings) may be replaced by substitute features serving the equivalent or similar purposes, i.e., unless particularly described, each feature is only an example of a series of equivalent or similar features.

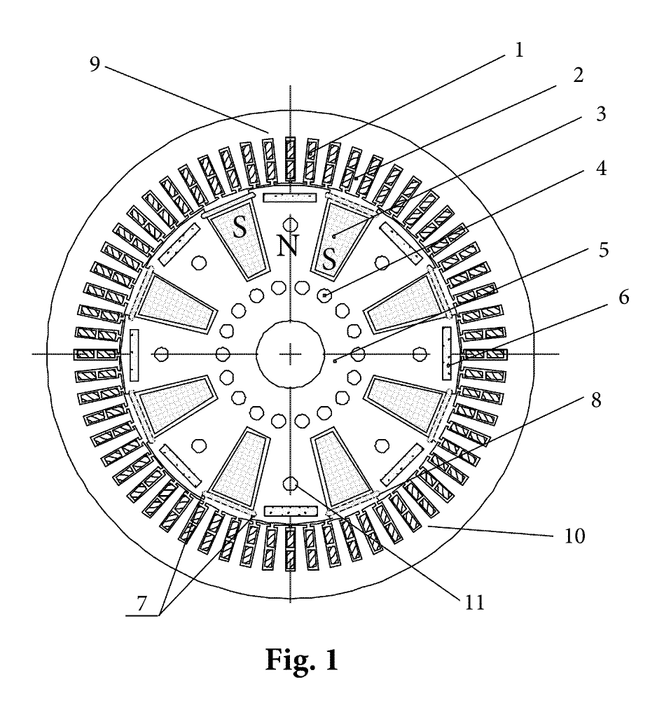

As shown in FIG. 1, in a particular embodiment, a steel-magnet embedded mixed excitation motor, including a stator 9 and a rotor 10 disposed in the stator 9. The stator 9 is made of a stator core 2 with armature windings 1 embedded therein; the rotator 10 includes a rotor sheet 5, the steel magnets 6 and an excitation winding 3, wherein the stator 9 and the rotor 10 are made of stalloy. The rotor sheet 5 has several evenly dispersed punching slots, which makes the rotor 10 form several poles. The steel magnets 6 are embedded in the poles at the side near excircle and distributed alternately following the pole N and the pole S of the rotor 10. Excitation windings 3 are directly spooled on the poles of rotor 10 and alternately distributed counterclockwise and clockwise following the pole N and the pole S of the rotor 10.

The steel magnets 6 are of a radial magnetizing type.

The quantity of the poles is equal to the number of the poles of the motor.

The steel magnets 6 are arranged under the pole N of the rotor 10 and the excitation windings 3 are arranged under the pole S of the rotor 10.

The steel magnets 6 are arranged under the pole S of the rotor 10 and the excitation windings 3 are arranged under the pole N of the rotor 10.

The stator 9 comprises a concentrated winding structure or distributed winding structure.

The symmetrical flutes 7 are arranged on the punching slots at the side near the excircle, and the flute wedges 8 are arranged in the symmetrical flutes 7.

Several accessory holes 4 are formed in inner side of the rotor sheet 5.

Heat-emission holes 11 are formed in the middle, near the steel magnets 6, of the rotor sheet 5.

The steel magnets 6 are located at mid-positions of the poles, and the dimension of the distance between the two sides of the steel magnets 6 and the punching slots is less than or equal to the dimension of the distance between the two sides of steel magnets 6 and the excircle edge of the rotor 10. The idling back electromotive force of the motor and the mixing degree of the steel magnet and winding are determined by the ratio of the dimension of the distance between the two sides of the steel magnets 6 and the excircle edge of the rotor 10 to the width of the steel magnets 6. Generally, when the idling back electromotive force is greater, the steel magnets 6 are closer to the external side of the poles to reduce the magnetic-flux leakage of the steel magnets. On the contrary, the steel magnets 6 are positioned farther from the external side of the poles to increase the magnetic-flux leakage of the steel magnets.

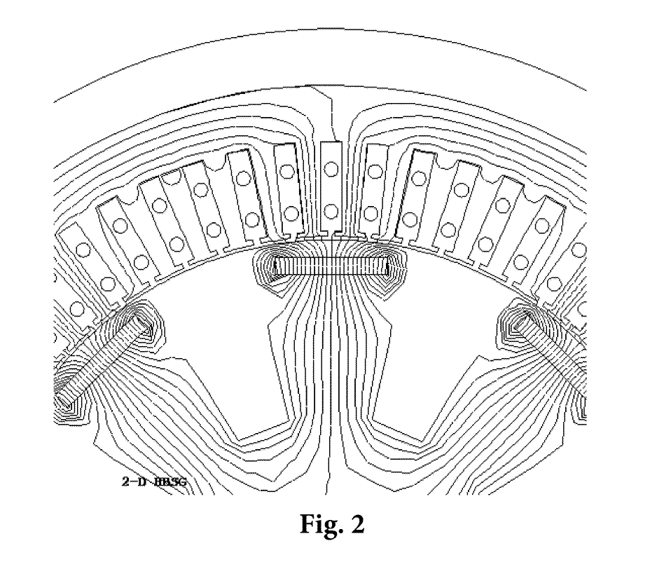

As shown in FIG. 2, the excitation of the motor is generated by the steel magnets when the excitation windings 3 are not energized. The simulation diagram shows that the pole excitation is only generated by the steel magnets 6 in the absence of an exciting current. However, as the steel magnets 6 are enveloped by magnetic materials, most of its excitation flux forms return circuits in the interior of rotor sheet 5, and the excitation for an air gap is small. Therefore, the magnetism density of the stator is lower in the absence of an exciting current, satisfying the requirements of the back electromotive force when the motor is running at a high-speed; the motor also realizes a small iron loss in such an arrangement.

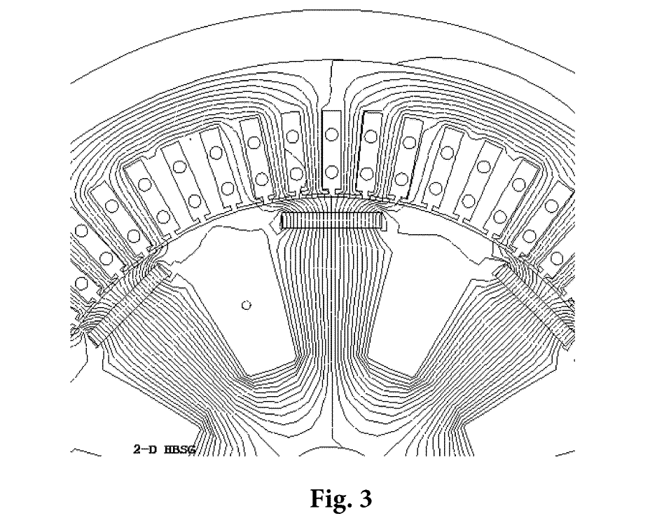

FIG. 3 shows the motor's distribution of magnetic field lines when the exciting current is energized to work and generates polarity; this is the same arrangement the auxiliary steel magnet. The distribution of the motor's magnetic field lines is shown in FIG. 3. When the excitation windings 3 excite in a positive direction, the magnetic-flux leakage of the steel magnets 6 is effectively counteracted, thereby increasing the excitation flux. As the exciting current increases, the magnetic-flux leakage magnetic circuit of the steel magnets 6 disappears, forming a common excitation effect by the excitation winding 2 and the steel magnets 6. Thus, the excitation flux can be effectively controlled by manipulating the exciting current.

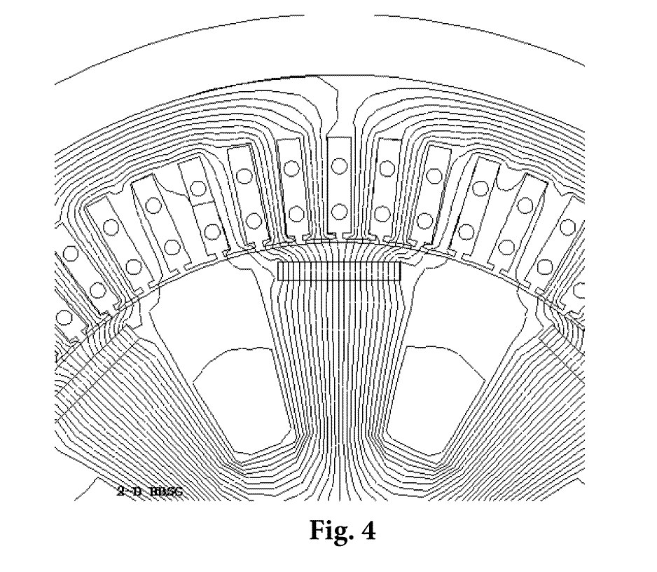

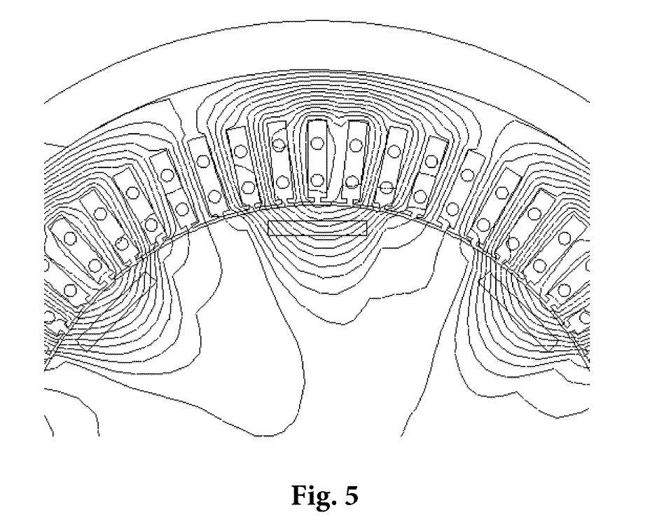

When the motor is burdened with a load, both the stator and the rotor generate a magnetic field to produce an air gap. FIGS. 4 and 5 demonstrate the the load magnetic field distributions for conventional excitation and the present invention respectively when the exciting current and load current are equivalent. After the poles of the rotor 10 are embedded into the steel magnets 6, the rotor 10 has an improved capacity of resisting armature reactions. In contrast, armature reactions greatly affect conventional excitation motors; the position of the air gap field in the motor changes relative to the idling magnetic field. Few of the pole's magnetic fields of the rotor have already passed through an iron core at a rotor yoke; the torque generated by the magnetic field of the same pole tends to be mutually counteracted, and the output torque is smaller. In the present invention, the direction of the synthetic magnetic field after the steel magnets 6 are embedded is more stable relative to the idling magnetic field; and, the rotor magnetizers on the two sides of the steel magnet generate a reluctance torque channel. The directions of magnetic field lines under the same pole are basically the same and produce an ideal effect of joint forces. For example, given the same excititation and load current, calculations performed by simulation software demonstrate that the peak torque generated by the motor in the present invention is more than five times that of the conventional excitation motor.

The particular embodiment, as described above, provides a further technical solution and advantageous effect of the present disclosure. However, this is only a particular embodiment of the present invention; it does not limit the the present invention. Rather, the present invention extends to any new feature or any new combination disclosed in this specification, in addition to any step of any new method or process disclosed or any new combination disclosed.

What is claimed is:

1. A steel-magnet embedded mixed excitation motor, comprising a stator and a rotor disposed in said stator; wherein said stator contains a stator core with armature windings embedded therein; wherein said rotor further comprising a rotor sheet, steel magnets and an excitation winding; wherein said steel-magnet embedded mixed excitation motor further comprising a stator and rotor that are made from stalloy;
wherein said rotor sheet further comprising a plurality of evenly dispersed punching slots, wherein said rotor further comprising several poles; wherein said steel magnets are embedded in said poles at the side near the excircle, wherein said steel magnets are distributed alternately following the pole N and the pole S of said rotor; and
wherein said excitation windings are directly spooled on the poles of said rotor and distributed alternately counterclockwise and clockwise following said pole N and said pole S of said rotor.

2. The steel-magnet embedded mixed excitation motor according to claim 1, wherein said steel magnets are of radial magnetizing type.

3. The steel-magnet embedded mixed excitation motor according to claim 1, wherein the quantity of said poles is equal to the number of the poles of said motor.

4. The steel-magnet embedded mixed excitation motor according to claim 1, wherein the steel magnets are arranged under said pole N of the rotor; wherein the excitation windings are arranged under said pole S of said rotor.

5. The steel-magnet embedded mixed excitation motor according to claim 1, wherein the steel magnets are arranged under said pole S of said rotor; wherein the excitation windings are arranged under said pole N of said rotor.

6. The steel-magnet embedded mixed excitation motor according to claim 1, wherein the stator further comprising a concentrated winding structure or distributed winding structure.

7. The steel-magnet embedded mixed excitation motor according to claim 1, wherein the symmetrical flutes are arranged on the punching slots at the side near the excircle, and wherein flute wedges are arranged in said symmetrical flutes.

8. The steel-magnet embedded mixed excitation motor according to claim 1, wherein a plurality of accessory holes are formed in the inner side of the rotor sheet.

9. The steel-magnet embedded mixed excitation motor according to claim 1, wherein the heat-emission holes are formed in the middle, near steel magnets, of said rotor sheet.

10. The steel-magnet embedded mixed excitation motor according to claim 1, wherein the heat-emission holes located on the rotor sheet; wherein each heat-emission hole correspond to a steel magnet.

11. The steel-magnet embedded mixed excitation motor according to claim 1, wherein the steel magnets are located at a middle position of said poles, and wherein the dimension of the distance between the two sides of the steel magnets and the punching slots is less than or equal to the dimension of the distance between the two sides of the steel magnets and the excircle edge of the rotor.
